(19) United States
(12) Patent Application Publication
(10) Pub. No.: US 2024/0112280 A1
(43) Pub. Date: Apr. 4, 2024

(54) EVENT ATTRIBUTION BY EXPERIENCE AND CONTENT

(71) Applicant: AT&T Intellectual Property I, L.P., Atlanta, GA (US)

(72) Inventors: Eric Zavesky, Austin, TX (US); Qiong Wu, Bridgewater, NJ (US); Aritra Guha, Edison, NJ (US); Jianxiong Dong, Pleasanton, CA (US)

(21) Appl. No.: 17/937,896

(22) Filed: Oct. 4, 2022

(51) Int. Cl. G06Q 50/00; H04W 12/64; H04W 12/69

(52) U.S. Cl. CPC G06Q 50/01; H04W 12/64; H04W 12/69

(57) ABSTRACT

An architecture related to the creation of, and attribution to, experiences based on location, popularity, captured media, and/or objects. A method can comprise receiving social media data associated with a user associated with a user identity, generating an attributable identity token based on the social media data and a learning model, wherein the attributable identity token is associated with the user identity and is representative of location data and experience data, and wherein the learning model comprises a collection of rules, and disseminating, by the device, the attributable identity token to a group of user identities associated with a social media operator entity.

### TECHNICAL FIELD

The disclosed subject matter relates to the creation of, and attribution to, experiences based on location, popularity, captured media, and/or objects.

### BACKGROUND

Public places such as zoos, animal/plant exhibits, public theme parks often have an extremely high popularity demand, however, these public places generally do not have the means to identify the popularity of their attractions in order to generate revenue for uses for the public good. To date, there has been no way to channel the popularity of one object or activity and use it for upgrading the popularity of a not-as-popular object or activity.

### BRIEF DESCRIPTION OF DRAWINGS

FIG. 1 is an illustration of a system that effectuates and/or facilitates the creation of, and attribution to, experiences based on location, popularity, captured media, and/or objects, in accordance with aspects of the subject disclosure.

FIG. 2 provides illustration of a flow chart, time sequence chart, or method that can be used to effectuate and/or facilitate the creation of, and attribution to, experiences based on location, popularity, captured media, and/or objects, in accordance with aspects of the subject disclosure.

FIG. 3 provides illustration of a flow chart, time sequence chart, or method that can be used to effectuate and/or facilitate the creation of, and attribution to, experiences based on location, popularity, captured media, and/or objects, in accordance with aspects of the subject disclosure.

FIG. 4 provides illustration of a flow chart, time sequence chart, or method that can be used to effectuate and/or facilitate the creation of, and attribution to, experiences based on location, popularity, captured media, and/or objects, in accordance with aspects of the subject disclosure.

FIG. 5 provides illustration of a flow chart, time sequence chart, or method that can be used to effectuate and/or facilitate the creation of, and attribution to, experiences based on location, popularity, captured media, and/or objects, in accordance with aspects of the subject disclosure.

FIG. 6 provides further depiction of a flow chart, time sequence chart, or method that can be used to effectuate and/or facilitate the creation of, and attribution to, experiences based on location, popularity, captured media, and/or objects, in accordance with aspects of the subject disclosure.

FIG. 7 provides yet further depiction of a flow chart, time sequence chart, or method that can be used to effectuate and/or facilitate the creation of, and attribution to, experiences based on location, popularity, captured media, and/or objects, in accordance with aspects of the subject disclosure.

FIG. 8 depicts another flow chart, time sequence chart, or method that can be used to effectuate and/or facilitate the creation of, and attribution to, experiences based on location, popularity, captured media, and/or objects, in accordance with aspects of the subject disclosure.

FIG. 9 is a block diagram of an example embodiment of a mobile network platform to implement and exploit various features or aspects of the subject disclosure.

FIG. 10 illustrates a block diagram of a computing system operable to execute the disclosed example embodiments.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

The disclosed subject matter, in accordance with various embodiments, provides a system, apparatus, equipment, or device comprising: a processor (and/or one or more additional processors), and a memory (and/or one or more additional memories) that stores executable instructions that, when executed by the processor, facilitate performance of operations. The operations can comprise receiving social media data associated with a user identity from social media operator entity equipment associated with a social media operator entity, creating, based on the social media data and a learning model representative of a collection of rules, an attributable identity token representing experience data representative of experiences associated with the user identity and location data representative of locations associated with the experiences, and distributing the attributable identity token to social media accounts associated with a group of user identities comprising the user identity, wherein the group of user identities is associated with the social media operator entity.

Further operations can comprise identifying, based on the social media data, a location of the location data and a time corresponding to the location, and determining, based on the location and the time, that a user associated with the user identity attended an event that took place at the location and the time, clustering the attributable token in a cluster of attributable identity tokens based on a time stamp value included in the social media data, generating an experience token based on the experience data, and wherein the experience data comprises content input via a social media account associated with the user identity, and distributing the experience token to the social media accounts associated with the group of user identities.

In embodiments where the user identity is a first user identity, the operations can further comprise, based on the distributing of the experience token, determining that user input, associated with a second user identity that is a member of the group of user identities, has resulted in the experience token being updated.

In regard to the foregoing, the location data can comprise a coordinate with a geographic longitude and latitude associated with the event. Also, the location data can represent geo-fencing data indicative of boundaries associated with the user identity, wherein the location of the location data can comprise a geo-fence of the geo-fencing data indicative of a boundary associated with the event. Further, the user input associated with the second user identity that has resulted in the experience token being updated can comprise a comment input with respect to the experience token associated with the second user identity that results in the comment being associated with the experience token. Moreover, the user input associated with the second user identity that has resulted in the experience token being updated can also comprise an emoticon input with respect to the experience token associated with the second user identity that results in the emoticon being associated with the experience token.

In accordance with further embodiments, the subject disclosure describes methods and/or processes, comprising a series of acts that, for example, can include: receiving, by a device comprising a processor, social media data associated with a user associated with a user identity, and generating, by the device, an attributable identity token based on the social media data and a learning model. The attributable identity token is associated with the user identity and is representative of location data representative of locations associated with the user identity and experience data representative of experiences associated with the user identity. The learning model applies a collection of rules. The acts can further comprise disseminating, by the device, the attributable identity token to a group of user identities associated with a social media operator entity.

Additional acts can comprise, based on geographic coordinate data associated with the location data, classifying, by the device, the attributable identity token and associating the attributable identity token with a collection of attributable identity tokens associated with the geographic coordinate data, or, based on the attributable identity token, generating, by the device, an experience token representing content input via a social media account associated with the user identity describing an experience that occurred at an attraction associated with the location data. As another option, when the user identity is a first user identity, the acts can comprise distributing, by the device, the experience token to social media accounts respectively associated with user identities comprising at least the first user identity and a second user identity.

Further acts can comprise determining, by the device, that the emoticon data, representing a graphic exhibiting a positive reaction to the experience that occurred at the attraction, has been input via a social media account associated with the second user identity, or adapting, by the device, a learning rule of the collection of rules applied by the learning model based on the emoticon data.

In the foregoing context, the attributable identity token can be an element of a linked list of attributable identity tokens, wherein at least the location data is at a head end of the element of the linked list of the attributable identity tokens, and the experience data is linked to the head end.

In accordance with still further embodiments, the subject disclosure describes machine readable media, a computer readable storage devices, or non-transitory machine readable media comprising instructions that, in response to execution, cause a computing system (e.g., apparatus, equipment, devices, groupings of devices, etc.) comprising at least one processor to perform operations. The operations can include: receiving, from a server of a social media operator entity, social media data representative of social media interactions associated with a user associated with a user identity. The operations can also include registering, based on the social media data and a learning model representative of a collection of rules, an attributable identity token representing experience data representative of an experience associated with the user identity and location data representative of locations associated with the user identity. The operations can further include distributing the attributable identity token to respective social media accounts of a group of user identities associated with the social media operator entity.

Other operations can include based on received geographic coordinate data associated with the location data and received timing data associated with the geographic coordinate data, classifying the attributable identity token and including the attributable identity token in a collection of attributable identity tokens associated with the geographic coordinate data.

As alluded to in the background, public places, such as zoos, animal/plant exhibits, public theme parks, and the like, often have extremely high popularity; however, currently there are no facilities to identify the popularity of these attractions in order to generate revenue for uses in the “public good.” Some activists suggest that identifying and measuring the popularity of attractions can be a golden opportunity to raise money to support, for instance, animals such as leopards, panda bears, and/or whales, through the introduction of something referred to as a species royalty—essentially a percentage of the proceeds from the sale of any animal-print items could go to support actual leopards, panda bears, and/or whales. Modern mechanisms such as blockchain, fingerprinting, location indicators, and check-ins can be harnessed to automatically attribute these activities (experiences) to specific events, attractions, objects, and locations.

The subject description also addresses how one can channel the popularity of one object (e.g., leopards, panda bears, butterflies, and/or whales, and the like) and use this initial popularity to upgrade the popularity of not-as-popular objects (e.g., komodo dragons, snakes, insects, etc.). Also, the subject description further addresses how one can preserve individual interests while dispersing demands. Often huge crowds may make an experience not-as-enjoyable for some. Can these huge crowds be dispersed to more popular locations to promote a “nearby” content? Can these dispersal techniques be used to learn what makes something “popular” and create “popular” content? Further, can the learning regarding what makes something “popular” and “popular” content be used to inspire creation of even more content? The various embodiments described herein provide processes and vehicles to enable these scenarios, answering these questions in the affirmative.

The disclosure herein pertains to linking spatial activities (e.g., visiting a zoo or public park) to a unique user entity experience(s), or those associated with a user identity that identifies the user entity; adding an ability to audit, inform, and attribute subsequent activity to those experiences; empowering locations (e.g., national parks), objects (e.g., famous lion in a zoo), and parts of non-traditional experiences (e.g., sunset or turtle release programs) to receive attribution/credit for their inspiration and reuse in content.

Further, the disclosure relates to unifying content-based fingerprinting to unique experiences for future attribution and sharing. Conventionally, unique tags (e.g., hash tags—metadata tags preceded by the hash (or pound) sign) or explicit user endorsement have been needed to understand the source of information. Additionally, the disclosure relates to system-guided generation of tokens for unique experiences based on exposure and popularity; this feature allows for the passive generation and attribution of experiences depending on generated location, experience, and/or content metrics data provided by user identities. Moreover, the disclosure provides for the ability to identify, re-create, or diversify experiences; with token-based attribution and/or registration, the disclosed systems and methods can help subsequent visitors to the experience to get similar, divergent, or updated experiences for their own derived content. In addition, the subject disclosure provides for the ability to generate and derived revenue streams, attribution, access control for an experience based on the popularity and sharing of experiences by user identities. Furthermore, the disclosure provides opportunities to modify/diversify content within an experience. In this regard, supporting “mash up,” social posting, and modification of content at an experience, the disclosed systems and methods can recommend personalization and facilitate its sharing and background attribution to a source.

As a high level synopsis, the disclosure provides a system for novel creation of, and attribution to, experiences by location, popularity, captured media, and/or objects. The various embodiments can geographically identify a place (location) and experiences, provided by user entities or associated with user identities, as attributable identity tokens, detect participation or interactions at the place based on the attributable identity tokens, and provides the ability to trace and attribute the attributable identity tokens to an event or an attraction.

The technical and commercial benefits provided by the disclosed various embodiments include adding trust and traceability of a location and photos; providing aggregated attribution to determine tastemakers, trendsetters, and popular contributors; protecting the environment (e.g., limit or facilitate participation in events and/or attractions); providing better, richer and more personalized/similar experiences achieved by token-based attributes; inspiring the future content consumption by distilling the attributes (e.g., views, audio, location, weather, season, . . . ) from popular events/attractions; and helping non-profit places to survive and maintain (e.g., trigger positive feedback (e.g., post images on mapping websites that provide satellite pictures and road maps for anywhere in the world, and/or upload onto social media websites), or to attract more visitors and advertising and encourage people to share their experiences and recommend these venues to others.

The subject disclosure, in general, provides systems and methods for the novel creation of, and attribution to, experiences, for example, by location, popularity, captured media, and/or objects. The described embodiments can identify geographic locations and a user's experiences at the identified geographic locations using an attributable identity token that can represent the identified geographic location, the user's perceived experience interacting with the geographic location, and/or the events/attractions and/or objects associated with the geographic location. The attributable identity token can comprise, for example, a register of a collection of registers, a tuple of a group of tuples (e.g., ordered lists or ordered sequences of one or more distinct objects that belong to a group of distinct objects), a linked list of an aggregation of linked lists, a hash of hashes, multidimensional arrays, tables, a tree of hierarchical tree structures, etc.

The register of the collection of registers, tuples of the group of tuples, etc. can be used to associate, classify, and/or cluster animals, plants, locations, and/or events/attractions, for instance, to a respective databases of known databases used to store data representing animals, plants, locations, and/or events/attractions. For example, a first database of the known databases can represent a database used for data representing animals, a second database of the known databases can represent a database used for data representing plants, a third database of the known databases can represent a database used for data representing locations, and/or a fourth database of the known databases can represent a database used for data representing events/attractions.

The detailed example embodiments can identify geographic locations, such as zoos, public parks, music concerts, and the like by using individuated user input (and/or groups of individual user input) received, for instance, from one or more social networking sites, such as online social media and social networking services (e.g., interactive technologies that facilitate and/or effectuate the creation and sharing of information, ideas, interests, and other forms of expression), multimedia instant messaging applications, multi-user blogging and/or micro-blogging services where users post and interact via messages, etc. In some embodiments, the various example embodiments can identify zoos, public parks, public events/attractions, using facilities provided by a global navigation satellite systems (GNSS) that can provide geo-location and/or time information to appropriately configured receivers situated anywhere on or near the Earth where there is an unobstructed line of sight to global positioning system (GPS) satellites. In additional and/or alternative embodiments, the locations of zoos, public parks, public events/attractions, etc. can be determined using geo-location and/or geo-fencing tags that can have been embedded, for example, in text messages and/or images that users can have taken when they attended, for example, a public event/attraction. In some instances, the geo-location and/or geo-fencing tags can be supplied from mobile network operator (MNO) entity core network equipment (e.g., base station equipment, gateway equipment, multi-access edge computing (MEC) equipment, self organizing network (SON) equipment, radio access network (RAN) intelligent controller (RIC) equipment, and the like. In other instances, geo-location and/or geo-fencing tags can be obtained from internet of things (IoT) equipment associated with zoos, public parks, public events/attractions, etc.

In some embodiments disclosed herein, public parks, public events/attractions, business conferences and/or political gatherings, museums, and the like can be identified based on attributable identity tokens that the public parks, public events/attractions, business and/or political conferences, museums, and the like, can embed into images captured and/or text messages sent while the user is using the facilities associated with event/attraction spaces and/or the public event/attractions (e.g., attributable identity tokens can be embedded when a user uses, via user equipment (UE), the event/attraction space's free wireless facilities supplied by the event/attraction host/organizer). Additionally and/or alternatively, attributable identity tokens can be embedded into captured images and/or text messages where the user, using their UE, intentionally scans, for example, a linear barcode, matrix barcode (e.g., quick response (QR) code), and/or a multidimensional barcode associated with the event/attraction host/organizer, public event/attraction space, business and/or political conference organizer, museum, etc. Further, in other embodiments, attributable identity tokens can be pushed to a user's UE when the user enters the event/attraction space, whereupon user identity approval and acceptance of the attributable identity tokens, the attributable identity tokens can be associated with images and/or text messages that a given user, associated with the user identity, can transmit via a user device during their visit to, and/or subsequent to (e.g., after they have departed the vicinity of) the public parks, public events/attractions, business and/or political conferences/gatherings, museums.

Based on the attributable identity tokens the described embodiments can determine popularity values to be associated with the visited public parks, public events/attractions, museums (and/or objects, such as the fauna and flora within public parks, particular art works with museums, landmarks [e.g., Niagara Falls, Taj Mahal, the Forbidden City, etc.], and/or content of public events/attractions [e.g., music concerts, poetry recitals, etc.], and the like). The popularity of values can, for instance, be based on the quantity of attributable identity tokens from disparate user identities that have been registered to databases associated with social media platforms.

The described example embodiments can detect participation through the attributable identity tokens, whereupon user identity digital actions, user identity presence, and the like can be used to determine a popularity and/or importance of a particular location, object, and the like, of an experience associated with the location and/or object. In some instances, the disclosed embodiments can limit access or change/adjust one or more costs of an event/attraction based on supply models and demand models, wherein the supply models and demand models can, for example, be based on popularity and/or interactions with the attractions and/or objects associated with the event/attraction. In some embodiments, popularity and/or attributable identity token values can be determined as a function of social media data attributes, such as likes, numbers of views a particular attributable identity token receives on one or more social media operator entity infrastructure. In some instances, a price value associated with a particular attributable identity token can be determined using an auction process (e.g., variations of an ascending price auction, variations of an open descending price auction, variants of a clock auction, variations of an open-outcry descending-price auction, etc.). In some aspects, the value of a particular attributable identity token can be determined as a function of the volume of attributable identity tokens that are exchanged within defined periods of time.

Further, one or more of the described example embodiments herein can trace and attribute the attributable identity tokens to events and/or attractions, wherein the attributable identity tokens can be applied for financial operations, such as payments, royalties, tax allocation, and the like. Further in accordance with additional embodiments, the attributable identity tokens can be used for exchange.

As mentioned, the subject disclosure provides functionalities and/or facilities for the creation of, and attribution to, experiences based on location, popularity, captured media, and/or objects. In effectuating the foregoing, core equipment, such as network equipment can initiate the following actions and/or processes: (a) based on received social media data received, for example, from social media operator entity equipment, and learning model data representing one or more artificial intelligence paradigm, machine learning model, neural network model, big data/data mining analytic model, and the like, catalog and register geographic locations, attractions at the geographic locations, attractions associated with the geographic locations, events occurring at the attractions at the geographic locations, and/or interactions and experiences that a user identity (e.g., a user) can have had at the geographic locations, etc., as one or more attribute identity tokens; (b) based on the one or more attributable identity tokens, generate and issue experience tokens; (c) based on the attribute identity tokens and the experience tokens, detect user identity participation data; (d) limit or facilitate user identity participation in an event and/or interaction with an attraction or object at the event; (e) in response to determining that the experience token has been distributed with a social media network operator entity network, monitor for changes associated with the attributable identity token data; (f) based on the changes associated with the attributable identity token data, update the attributable identity token data with the changes; and/or (g) based on the updates to the attributable identity token data, modify learning model data and adapt a learning model based on the modified learning model data.

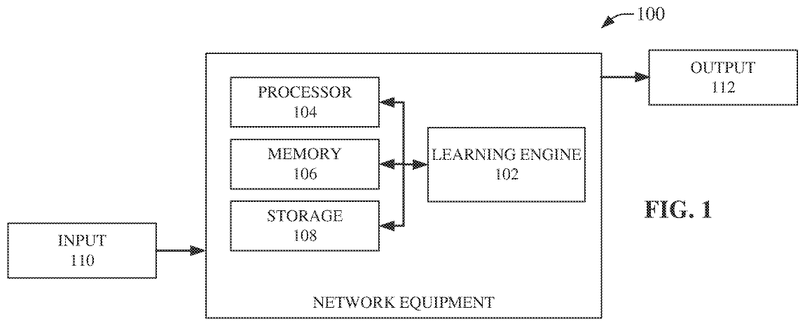

Now with reference to FIG. 1 that illustrates a system 100 (e.g., network equipment) that effectuates and/or facilitates the creation of, and attribution to, experiences based on location, popularity, captured media, and/or objects in accordance with various embodiments. As illustrated system 100 can comprise learning engine 102 that can be communicatively coupled to processor 104, memory 106, and storage 108. learning engine 102 can be in communication with processor 104 for facilitating operation of computer and/or machine executable instructions and/or components by learning engine 102, memory 106 for storing data and/or the computer or machine executable instructions and/or components, and storage 108 for providing longer term storage for data and/or machine and/or computer machining instructions. Additionally, system 100 can receive input 110 for use, manipulation, and/or transformation by learning engine 102 to produce one or more useful, concrete, and tangible result, and/or transform one or more articles to different states or things. Further, system 100 can also generate and output the useful, concrete, and tangible results, and/or the transformed one or more articles produced by learning engine 102, as output 112.

In some embodiments, system 100 can be IoT small form factor equipment capable of effective and/or operative communication with a network topology (e.g., cellular network). Examples of types of mechanisms, equipment, machines, devices, apparatuses, and/instruments can include virtual reality (VR) devices, wearable devices, heads up display (HUD) devices, machine type communication devices, and/or wireless devices that communicate with radio network nodes in a cellular or mobile communication system. In various other embodiments, system 100 can comprise tablet computing devices, handheld devices, server class computing machines and/or databases, laptop computers, notebook computers, desktop computers, cell phones, smart phones, commercial and/or consumer appliances and/or instrumentation, industrial devices and/or components, personal digital assistants, multimedia Internet enabled phones, Internet enabled devices, multimedia players, aeronautical/avionic devices associated with, for example, aerial UE and/or unmanned aerial vehicles (UAVs), orbiting satellites and/or associated aeronautical vehicles, and the like.

Learning engine 102 in accordance with various embodiments, in conjunction with one or more learning model, can catalog and register places (e.g., geographic locations) and user experiences, associated with a user identity, that a corresponding user can have had interacting objects and/or attractions associated with the places. The places and user experiences can have been received as social media data from one or more social media operator entity infrastructure. Each place and associated user experience can be conjoined to form an attributable identity token. The attributable identity token can be unique and can comprise, for instance, video data, audio data, visual data, olfactory data, tactile data, location data, time of day data, and/or objects associated with the those data. Further, the attributable identity token can be generated and made unique, for example, by using multiparty blockchain processes, digital fingerprinting wherein attributes from one or more of the video data, audio data, visual data, location data, time of day data, and/or data associated with the objects can be used as sources of nonce strings to include and generate attributable identity tokens.

The attributable identity tokens, in some embodiments, can be based on the quality of the experience. For instance, a user identity can describe the experience with tag data describing the event as using high fidelity video only, or the event was an in-person event, or the event was an audio only event, etc. In accordance with further embodiments, the attributable identity tokens can be linked to local objects or attractions. For example, the attributable identity tokens can be linked to a statement, such as: “saw a specific animal, “saw an object,” “had a wonderful time at the music event,” and the like. The attributable identity tokens, based on linkages to experience based statements, can provide distinctions between events and/or attractions that can have occurred at the same location and/or at contemporaneous time periods. In another embodiment, these attributable identity tokens may be generated from active parts of the user experience (e.g. written text, spoken dialog, or visual tags) or from passive parts of the experience at the location (e.g. analysis of the video, audio, or location data to specifically generate an identity token for a specific animal or part or viewpoint of the location).

Learning engine 102 in accordance with some embodiments can detect user participation and can capture content representing social media data received, for example, from social media operator entity equipment. Typically, social media data can comprise event data, time data, location data, and/or experience data. Place data can comprise data received from GNSS equipment. GNSS data can provide geo-location (e.g., longitudinal and/or latitudinal coordination data) that can be used in order to demarcate (e.g., geo-fence) a defined geographic area within which an attraction and/or an event attended by a user identity is taking place. Further, GNSS data can also provide time data and/or time information. Based at least upon GNSS data learning engine 102 can determine the locations of zoos, public parks, public events/attractions, etc. Also, learning engine 102 can determine place data based on GNSS data that can have been embedded and/or associated with user identity generated content captured at the location using, for instance, geo-location and/or geo-fencing tags, for example, included in text messages and/or images that users can have taken when they attended an event and/or attraction.

In regard to event data, this can comprise information about the event, such as information regarding music concerts, art exhibitions, poetry recitals, business conferences, political gatherings, comic conventions, and the like, taking place at the location. Additionally, where the event is taking place at a location with historical and/or architectural significance, this information can also be included in the event data.

With respect to experience data, this can be entered via user input by a user associated with a user identity. For instance, experience data can be data that the user, as identified by his or her user identity, enters into their social media account in regard to their interactions with the location, event space, etc., commentary in regard to the attractions, music concerts and performers, etc. Further, experience data can also take the form of emoticons that have been included in the commentary (and responses by groups of user identities, e.g., friends, associates, etc., associated with the author user identity). Examples of typical emoticons, without limitation, can include the “like symbol,” “smiley faces,” “thumbs up,” “okay,” “thumbs down,” and the panoply of other symbols and/or emoticons associated with current social media practice.

In some embodiments, participation and/or interaction with the event and/or attractions associated with the event can be determined based on UE and/or IoT equipment presence within areas bounded by geo-fencing coordinate data.

Learning engine 102, based at least in part on one or more of place data, event data, time data, location data, and/or experience data, can determine whether or not one or more attributable identity token can be associated with the received social media data. In instances where there is no extant attributable identity token data, learning engine 102, based on the social media data received earlier, can generate an attributable identity token data and affiliate one or more of place data, event data, time data, location data, and/or experience data with the recently generated attributable identity token data.

In addition, in some embodiments, learning engine 102 can limit and/or facilitate participation in events. For instance, learning engine 102 can perform trend analysis, and based on the detected trends, learning engine 102 can provide supply and/or demand limitations by modifying availabilities for users corresponding to user identities to attend events and/or attractions, suggest re-sharing of prior content (e.g., a user or user identity is associated with generated content associated with an event and/or attraction and/or system generated content associated with the event and/or attraction) associated with events and/or attractions (e.g., increase demand for a particular event and/or attraction). In this manner, learning engine 102 can increase public accessibility to events and/or attractions.

In other embodiments, learning engine 102 can discover related content that can be purchased at discount and/or for limited time periods (e.g., seasonal passes to attractions, discounted music concert tickets should a user, associated with a user identity, purchase early, discounted event tickets where the user purchases a ticket at the last minute, purchases tickets to events at bulk rates, and the like). For instance, using one or more attributable identity token that can have been generated earlier, for example, in association with a user identity (e.g., identified by the user identity and generated by a user associated with the user identity as an upcoming reminder event), event organizer, object owner (e.g., museum), art gallery, attraction provider, and the like, to identify events that are priced at a discount and/or events that are only for a limited time period (e.g., music concerts by musical acts that appear at a local venue for a single night, . . . ).

Additionally, learning engine 102, as content is distributed, can monitor and/or track attributable identity tokens as first groups of user identities distribute and/or propagate the attributable identity tokens amongst themselves and/or to second groups of user identities. Learning engine 102, in accordance with these embodiments, can attribute user identity feedback for metrics and quality associated to derived content, such as user identity initiated likes, reuse, personal preference, experience engagement, etc.

Learning engine 102 can also associate activities with attributable identity tokens for future consumption. For instance, learning engine 102 can facilitate payment, supply, popularity through one or more databases using command-line based double-entry bookkeeping applications, wherein accounting data is stored in a plain text files, using a simple format. Learning engine 102, in this vein, can propagate (e.g., using a linking or chaining structure, such as linked lists, hierarchical tree structures, a multiparty block chains, hash tables, etc.) the purchase, views, activity of content pieces back to an original event. If designated, payments can be distributed, and/or all content pieces can receive attribution credit (e.g., for popularity, leader board, etc.).

In regard to content, certain content can be associated with modification rights that, if approved, for example, by an upstream entity/identity (e.g., user/user identity, business/business identity, corporate entity/corporate identity, avatar/avatar identity, and the like) that controls the downstream content modification rights, such as the author, and/or user identity and/or machine/machine identity generator of the content can allow the content to be modified in order to derive additional new content. In some instances, learning engine 102 can have policies to restrict modification of original author and/or derived author content, wherein such policies can prevent, for instance, the propagation and/or dissemination of prohibited-speech, inclusion of material that is subject to ownership rights of another identity (e.g., copyright and/or other digital rights management implementations), inclusion of obscene, lurid, and/or sensational material, etc. Conversely, learning engine 102 can aid in, and/or facilitate, modification of content to form new content. Learning engine 102 can facilitate the modification of initial content to derive new content based on one or more rules. The rules can be based on one or more machine learning paradigm, neural network processes, cost to benefit analyses, and the like. For instance, in regard to cost benefit analyses, based on a group of previously determined rules, the costs associated with adopting a particular action can be compared with the benefits associated with adopting the action; where the benefits of adopting the action outweigh, even marginally, the costs associated with adopting the action, the action can be pursued. Further, in some embodiments, artificial intelligence technologies, neural networking architectures, collaborative filtering processes, machine learning techniques, Bayesian belief systems, big data mining and data analytic functionalities, and the like, can be employed, wherein, for example, multi-objective optimization (e.g., Pareto optimization) can be used to determine whether or not an action should be initiated and implemented. Multi-objective optimization can ensure that first actions or groups of first actions can only be implemented provided that other second actions or groups of other second actions will not be detrimentally affected.

Additionally and/or alternatively, learning engine 102 can use external social media input (e.g., input 110) that can comprise attributable identity token links and/or commentary, wherein the attributable identity tokens can be associated, or is attributable, to an identified experience and/or its captured content.

Learning engine 102, based at least in part on groups of attributable identity tokens and/or links/associations included in the groups of attributable identity tokens, can determine and learn about popular attribution identity tokens (e.g., attributable tokens that have been shared amongst group of user identities). Learning engine 102 can use one or more threshold values to determine and categorize whether or not an attributable identity token is popular or not. For instance, extremely popular attributable identity tokens can be used subsequently to generate additional content for future modification requests. Over time, learning engine 102 can propose alternate clustering, categorizations, and/or groupings of related content. For example, attributable identity tokens can be clustered based, for instance, on groups of common or similar events (e.g., visits to a zoo, visits to a defined local zoo, visits to a theme park during a particular month or on a defined day, . . . ). Further, attributable identity tokens can be classified based on a collection of similar occurrences (e.g., similarity of content occurring within a defined time period, similarity of content referring to the same event, etc.). Additionally, attributable identity tokens can be used, by learning engine 102, to categorize attributable identity tokens based, for example, on the number of times the attributable identity token has been shared amongst user identities associated with a social media network entity, and the clock time at which the attributable identity token were shared among user identities associated with the social media network entity. For instance, in regard to the clock timing when the attributable identity token was shared, this data can be used to gauge and/or infer a level of enthusiasm by a user associated with a user identity in regard to the event or attraction, wherein the more proximate to the timing of the generation, by the user, of the attributable identity token referring to the event or attraction, the more enthusiastic the user can have been about the event or attraction, which can be attributed to user identity corresponding to the user. Conversely, the time that may have elapsed as to when the attributable identity token was generated and shared relative to the event or attraction can also be a negative indication that the user identified by the user identity was not particularly appreciative of the event or attraction experience (e.g., when a content attribute associated with the attributable identity token indicates the user's/user identity's intense disapproval of the event, attraction, or a facility or service associated with the event or attraction; a “thumbs-down”). Further, in the context of the timing aspect, learning engine 102, for instance, can also use the timing associated with the generation of, and/or dispersal of, the attributable identity token related to an event or attraction through the social media universe as being indicative that content can be related to the same event or attraction. This is particularly the case where one or more fields associated with one or more generated and/or dispersed attributable identity token comprise content data pertaining to similar events, more or less contemporaneous time periods (e.g., same day, approximately same time of day, seasonal crop harvesting, heavy bloom and pollination periods, wildlife mating seasons, etc.), congruous or nearly congruous event locations, etc.

Learning engine 102, based at least in part on the categorizations, classifications, and/or clustering of attributable identity tokens, can use the categorizations, classifications, and/or clustering to stimulate overall usage to propose serial operations with regard to events, attractions, and objects. For instance, in the context of a zoo, learning engine based on the categorizations, classifications, and/or clustering of attributable identity tokens, and further based on content that can have been included in the attributable identity tokens, can suggest an order or rank in which various objects and/or attractions within an event should be viewed, taking note that some attractions can be more busy at certain times of the day. Further, learning engine 102 can also recommend alternative (similar) objects and/or attractions within the event, and/or similar and equivalent events based on the categorizations, classifications, and/or clustering of attributable identity tokens. In regard to learning engine 102 proposing similar and/or equivalent events based on the categorizations, classifications, and/or clustering of attributable identity tokens, learning engine 102, in some embodiments, can construct one or more hierarchical tree structure in order to determine whether or not a first event, attraction, and/or object is similar or equivalent to a second event, attraction, and/or object.

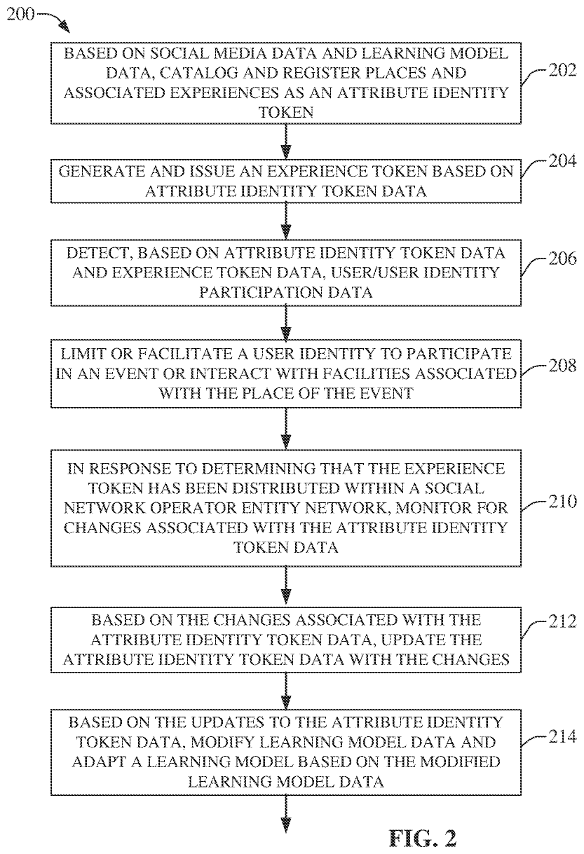

In view of the example embodiment(s) described above, example method(s) or process(es) that can be implemented in accordance with the disclosed subject matter can be better appreciated with reference to the flowcharts and/or illustrative time sequence charts in FIGS. 2-8. For purposes of simplicity of explanation, a example method disclosed herein is presented and described as a series of acts; however, it is to be understood and appreciated that the disclosure is not limited by the order of acts, as some acts may occur in different orders and/or concurrently with other acts from that shown and described herein. For example, one or more example methods disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a described example method in accordance with the subject specification. Further yet, the disclosed example method can be implemented in combination with one or more other methods, to accomplish one or more aspects herein described. It should be further appreciated that the example methods disclosed throughout the subject specification are capable of being stored on an article of manufacture (e.g., a computer-readable medium) to allow transporting and transferring such methods to computers for execution, and thus implementation, by a processor or for storage in a memory.

FIG. 2 illustrates a flow chart or method 200 that can be used to effectuate and/or facilitate the creation of, and attribution to, experiences based on location, popularity, captured media, and/or objects in accordance with various embodiments. Method 200 can commence at act 202 whereupon network equipment (e.g., learning engine 102 or comprising an instance of learning engine 102) can receive social media data from social media equipment associated with one or more social media network operator entities, and, based on the received social media data and an established learning model (or in instances where the learning model is yet to be established, a group of learning model training rules) comprising leaning model data (e.g., leaning model operating rules that can iterate, evolve, and modify the learning model over time), the network equipment can catalog and register places and associated experiences experienced by users/user identities at the places as one or more attribute identity token. In this regard, the social media data can comprise content generated by various users/user identities, wherein the content can include data detailing a user's/user identity's experiences at an event, and their experiences interacting with the attractions associated with the event. Additionally, social media data can also include information related to the time during which the user identity attended the event, as well as coordinate data that has been embedded with the social media data. In regard to the timing data representing the time duration that the user/user identity was attending the event and the coordinate data indicating the location of the event, this data can be obtained from GNSS data and/or one or more base station/cell tower equipment, internet of things equipment located in the general vicinity of the event.

At act 204, the network equipment, such as learning engine 102, can generate and issue an experience token based on the attribute identity token data. The experience token can be a unique token and can include video data, photographic data, audio data, location data, time data, object data, and the like, that can have been included in the social media data and that can have been cataloged and/or registered as attribute identity token data in association with experience data that a user associated with a user identity can have input.

At act 206, the network equipment, such as learning engine 102, can detect, based on the attribute identity token and/or the experience token, whether or not a user/user identity participated or interacted with the event to which the attribute identity token and/or the experience token pertain. Learning engine 102 can determine that the user/user identity participated and/or interacted with the event and/or the event's attractions and associated objects (e.g., lions, tigers, butterflies, interactive exhibits, and the like) by using user/user identity participation data that can have been included in the attribute identity token and/or the experience token.

At act 208, the network equipment, such as learning engine 102, can limit or facilitate user/user identity participation or interaction with attractions at the event and/or objects at the event. For instance, learning engine 102 can recommend to the user/user identity, based at least in part on experience token data and attributable identity token data, that the user/user identity should interact with certain attractions and/or objects at the event, such as the roller coasters available at the event location. The network equipment can also provide directions to the attraction location within the event location, as well as provide, to the user/user identity via a user device, additional and/or alternative or similar attraction locations when it is determined, by the network equipment, that the initial attraction location has extended wait times in comparison to the alternative and/or similar attraction locations within the event location. Further, the network equipment can also provide, to the user/user identity via a user device, an ordered or ranked list of attraction location associated with the event. For instance, learning engine 102 can inform the user/user identity that they should visit a first attraction, then visit a second attraction, and the like. The network equipment can base the ordering or ranking on factors such as wait times at the various attraction, popularity of the various attractions, historical importance of the attractions, the scenic perspectives of the various attractions, and the like.

At act 210, the network equipment, in response to determining that an experience token has been distributed within a social media network operator entity network/infrastructure to groups of users/user identities associated with the social media network operator entity network/infrastructure, can monitor for any modifications and/or changes that occur to experience token data and/or the attributable identity token data. For example, the network equipment can determine whether the groups of user identities have associated comments or commentary to the experience token data. In some embodiments, the network equipment can determine whether emoticons or emojis have been associated with the experience token data by one or more groups of user identities.

At act 212, based on the changes to the experience token data and/or the attributable identity token data, the network equipment can update the attributable identity token with the data changes, and at act 214, based at least in part to the updated attribute identity token data, the network equipment can adapt a learning model as a function of modified learning model data.

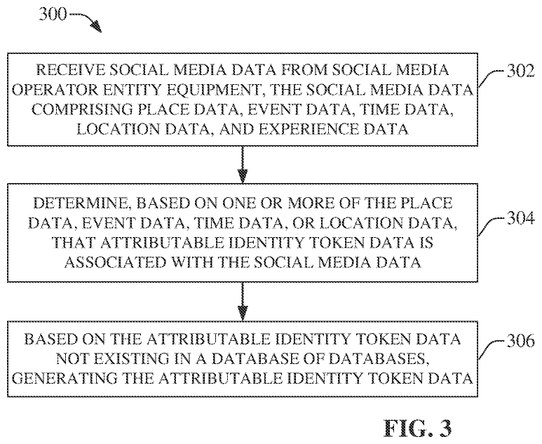

FIG. 3 depicts a further flow chart or method 300 that can be employed to effectuate and/or facilitate the creation of, and attribution to, experiences based on location, popularity, captured media, and/or objects in accordance with various embodiments, in accordance with various embodiments. Method 300 can begin at act 302, where learning engine 102, e.g., as deployed in network equipment, a network device or as part of a network service enabled for a user device, can receive, from social media operator entity equipment, social media data. The social media data can represent at least place data (e.g., geographic coordinate data based on data received from one or more of GNSS equipment, mobile network operator (MNO) network equipment, various small form factor IoT equipment proximate to the location), event data representing an event or attraction occurring at the location, time data representing a time during which a user/user entity is attending the event or attraction, and experience data representing content that a user/user identity can have entered as user input in regard to particular attractions at the place denoted by the place data. In regard to the time data, this information can be determined from signal data received from one or more of MNO network equipment (e.g., base station equipment), proximate IoT network equipment, and/or GNSS equipment. Further, time data can also be determined based on timing data that can have been embedded or associated with content, such as video files, audio files, photographs, and the like.

At act 304, learning engine 102 can determine, based on one or more of the place data, event data, time data, or location data that attributable identity token data is associated with the received social media data. At act 306, learning engine 102, based on determining that the attributable identity token does not exist in a database of databases, can generate the attributable identity token data and associated the generate attributable identity token data with the attributable identity token.

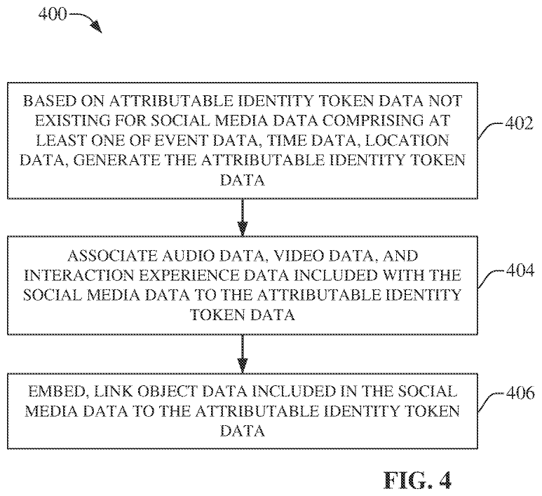

With reference to FIG. 4 that illustrates a flow chart, time sequence chart, or method 400 that can be used to effectuate and/or facilitate the creation of, and attribution to, experiences based on location, popularity, captured media, and/or objects in accordance with various embodiments Flow chart 400 can commence at act 402 whereupon learning engine 102 (e.g., as deployed in network equipment, a network device or as part of a network service enabled for a user device), based on attribution identity token data not existing for received social media data representative of at least one or more of event data, time data, and location data, can generate an attribute identity token. At act 404, learning engine 102 can associate audio data, video data, and interactional experience data included with the received social media data with the attributable identity token. At act 406, the attributable identity token can be linked to object data representative of objects that the user identity may have interacted with while at the attraction and/or event. The object data can be received together with the social media data and can be embedded within the attributable identity token.

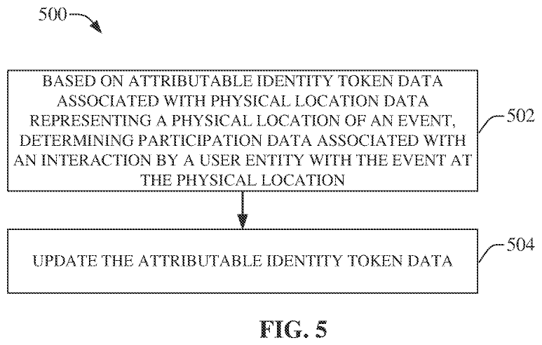

FIG. 5 illustrates a flow chart, time sequence chart, or method 500 that can be used to effectuate and/or facilitate the creation of, and attribution to, experiences based on location, popularity, captured media, and/or objects in accordance with various embodiments. Method 500 can begin at act 502 where learning engine 102 (e.g., as deployed in network equipment, a network device or as part of a network service enabled for a user device), using attribution identity token data associated with a physical location data representing a physical location of an event, can determine participation metric data associated with interactions by users/user identities with the event and one or more attractions associated with the event. At act 504, learning engine 102, using the participation metric data associated with the event and/or attractions at the event, can update the attribution identity token.

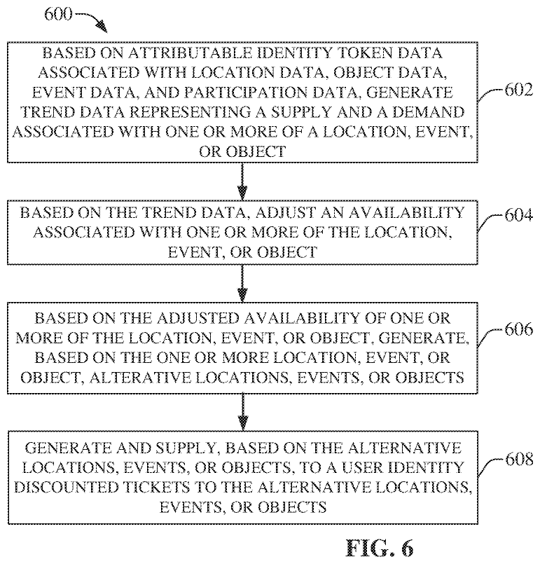

FIG. 6 is a further illustration of a flow chart, time sequence chart, or method 600 that can be used to effectuate and/or facilitate the creation of, and attribution to, experiences based on location, popularity, captured media, and/or objects in accordance with various embodiments. Method 600 can begin at act 602 where learning engine 102 (e.g., as deployed in network equipment, a network device or as part of a network service enabled for a user device), based on attribute identity token data associated with location data, object data, event data, and participation metric data, can generate trend data representing a supply and a demand associated with one or more of an event, an object, and/or attractions associated with the event. At act 604, learning engine 102, based on the generated trend data, can adjust the availabilities associated world more of the event, the location of the event, an object, and/or attractions associated with the event. At act 606, learning engine 102, based on the adjusted availability of the one or more of the location, event, object, and/or attractions associated with the event, can generate, based on the one or more location, event, object, and/or attractions associated with the event, one or more alternative location, alternative event, alternative object, and/or alternative attractions associated with an alternative event. At act 608, learning engine 102, based on the one or more alternative location, alternative event, alternative object, and/or alternative attractions associated with the alternative event, can generate and provide to a user/user identity discounted tickets to the alternative location, alternative event, alternative object, and/or alternative attractions associated with the alternative event.

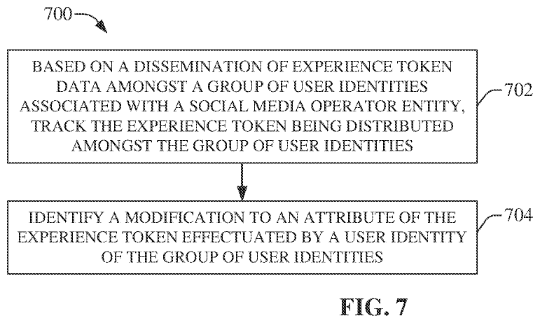

FIG. 7 is an illustration of a flow chart, time sequence chart, or method 700 that can be used to effectuate and/or facilitate the creation of, and attribution to, experiences based on location, popularity, captured media, and/or objects in accordance with various embodiments. Method 700 can begin at act 702 whereupon learning engine 102 (e.g., as deployed in network equipment, a network device or as part of a network service enabled for a user device), based on a dissemination of experience token data amongst a group of users/user identities associated with a social media operator entity, can track and monitor the experience token data as it is being distributed among the group of users/user identities. At act 704, learning engine 102 can identify a modification of the experience token data effectuated by a user/user identity of the group of users/user identities.

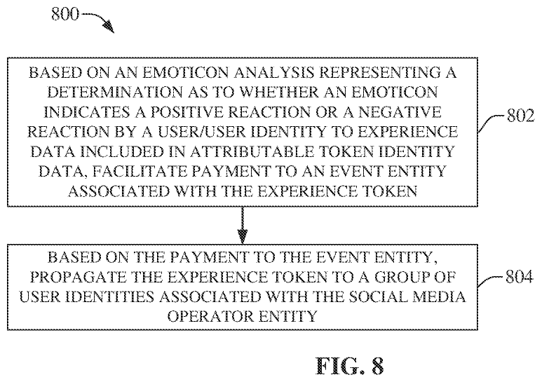

FIG. 8 is another illustration of a flow chart, time sequence chart, or method 800 that can be used to effectuate and/or facilitate the creation of, and attribution to, experiences based on location, popularity, captured media, and/or objects in accordance with various embodiments. Method 800 can commence at act 802 where learning engine 102 (e.g., as deployed in network equipment, a network device or as part of a network service enabled for a user device), based on an emoticon analysis representing a determination as to whether or not an emoticon received from a user/user identity indicates a positive reaction or negative reaction by a user/user identity to experience token data included in an attributable identity token, can facilitate payment to an event entity associated with the experience token. At act 804, learning engine 102, based on the payment to the event entity, can propagate the experience token to a group of users/user entities associated with the social media operator entity.

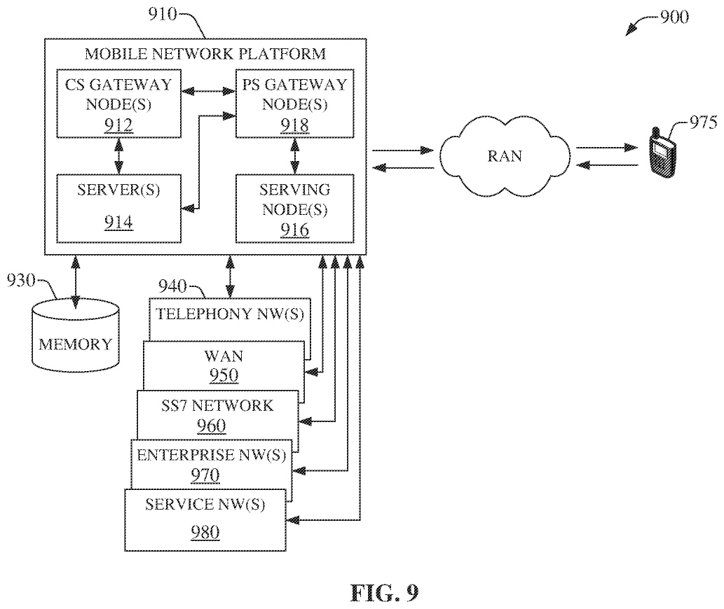

FIG. 9 presents an example embodiment 900 of a mobile network platform 910 that can implement and exploit one or more aspects of the disclosed subject matter described herein. Generally, wireless network platform 910 can include components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, wireless network platform 910 can be included in telecommunications carrier networks, and can be considered carrier-side components as discussed elsewhere herein. Mobile network platform 910 includes CS gateway node(s) 912 which can interface CS traffic received from legacy networks like telephony network(s) 940 (e.g., public switched telephone network (PSTN), or public land mobile network (PLMN)) or a signaling system #7 (SS7) network 970. Circuit switched gateway node(s) 912 can authorize and authenticate traffic (e.g., voice) arising from such networks. Additionally, CS gateway node(s) 912 can access mobility, or roaming, data generated through SS7 network 960; for instance, mobility data stored in a visited location register (VLR), which can reside in memory 930. Moreover, CS gateway node(s) 912 interfaces CS-based traffic and signaling and PS gateway node(s) 918. As an example, in a 3GPP UMTS network, CS gateway node(s) 912 can be realized at least in part in gateway GPRS support node(s) (GGSN). It should be appreciated that functionality and specific operation of CS gateway node(s) 912, PS gateway node(s) 918, and serving node(s) 916, is provided and dictated by radio technology(ies) utilized by mobile network platform 910 for telecommunication.

In addition to receiving and processing CS-switched traffic and signaling, PS gateway node(s) 918 can authorize and authenticate PS-based data sessions with served mobile devices. Data sessions can include traffic, or content(s), exchanged with networks external to the wireless network platform 910, like wide area network(s) (WANs) 950, enterprise network(s) 970, and service network(s) 980, which can be embodied in local area network(s) (LANs), can also be interfaced with mobile network platform 910 through PS gateway node(s) 918. It is to be noted that WANs 950 and enterprise network(s) 970 can embody, at least in part, a service network(s) like IP multimedia subsystem (IMS). Based on radio technology layer(s) available in technology resource(s) 917, packet-switched gateway node(s) 918 can generate packet data protocol contexts when a data session is established; other data structures that facilitate routing of packetized data also can be generated. To that end, in an aspect, PS gateway node(s) 918 can include a tunnel interface (e.g., tunnel termination gateway (TTG) in 3GPP UMTS network(s) (not shown)) which can facilitate packetized communication with disparate wireless network(s), such as Wi-Fi networks.

In embodiment 900, wireless network platform 910 also includes serving node(s) 916 that, based upon available radio technology layer(s) within technology resource(s) 917, convey the various packetized flows of data streams received through PS gateway node(s) 918. It is to be noted that for technology resource(s) 917 that rely primarily on CS communication, server node(s) can deliver traffic without reliance on PS gateway node(s) 918; for example, server node(s) can embody at least in part a mobile switching center. As an example, in a 3GPP UMTS network, serving node(s) 916 can be embodied in serving GPRS support node(s) (SGSN).

For radio technologies that exploit packetized communication, server(s) 914 in wireless network platform 910 can execute numerous applications that can generate multiple disparate packetized data streams or flows, and manage (e.g., schedule, queue, format . . . ) such flows. Such application(s) can include add-on features to standard services (for example, provisioning, billing, customer support . . . ) provided by wireless network platform 910. Data streams (e.g., content(s) that are part of a voice call or data session) can be conveyed to PS gateway node(s) 918 for authorization/authentication and initiation of a data session, and to serving node(s) 916 for communication thereafter. In addition to application server, server(s) 914 can include utility server(s), a utility server can include a provisioning server, an operations and maintenance server, a security server that can implement at least in part a certificate authority and firewalls as well as other security mechanisms, and the like. In an aspect, security server(s) secure communication served through wireless network platform 910 to ensure network's operation and data integrity in addition to authorization and authentication procedures that CS gateway node(s) 912 and PS gateway node(s) 918 can enact. Moreover, provisioning server(s) can provision services from external network(s) like networks operated by a disparate service provider; for instance, WAN 950 or Global Positioning System (GPS) network(s) (not shown). Provisioning server(s) can also provision coverage through networks associated to wireless network platform 910 (e.g., deployed and operated by the same service provider), such as femto-cell network(s) (not shown) that enhance wireless service coverage within indoor confined spaces and offload radio access network resources in order to enhance subscriber service experience within a home or business environment by way of UE 975.

It is to be noted that server(s) 914 can include one or more processors configured to confer at least in part the functionality of macro network platform 910. To that end, the one or more processor can execute code instructions stored in memory 930, for example. It is should be appreciated that server(s) 914 can include a content manager 915, which operates in substantially the same manner as described hereinbefore.

In example embodiment 900, memory 930 can store information related to operation of wireless network platform 910. Other operational information can include provisioning information of mobile devices served through wireless platform network 910, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 930 can also store information from at least one of telephony network(s) 940, WAN 950, enterprise network(s) 970, or SS7 network 960. In an aspect, memory 930 can be, for example, accessed as part of a data store component or as a remotely connected memory store.

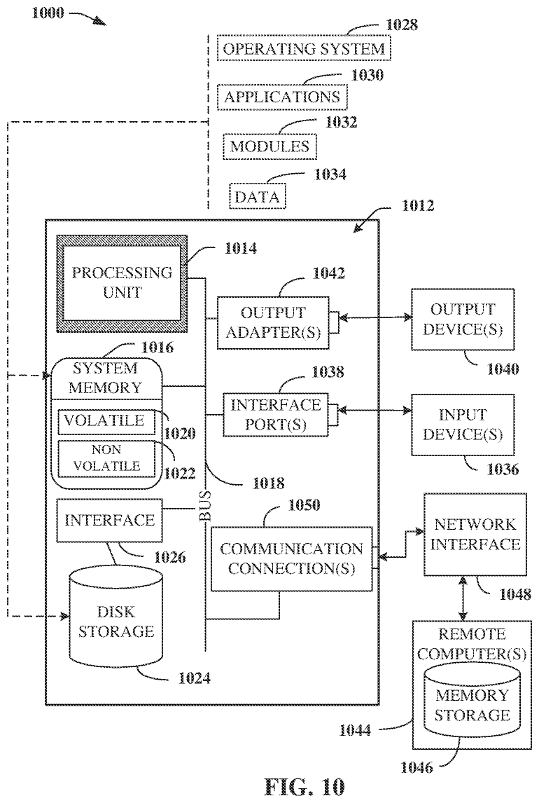

In order to provide a context for the various aspects of the disclosed subject matter, FIG. 10, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules include routines, programs, components, data structures, etc. that perform particular tasks and/or implement particular abstract data types.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory, by way of illustration, and not limitation, volatile memoryQWAT20 (see below), non-volatile memory 1022 (see below), disk storage 1024 (see below), and memory storage 1046 (see below). Further, nonvolatile memory can be included in read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, including single-processor or multiprocessor computer systems, mini-computing devices, mainframe computers, as well as personal computers, hand-held computing devices (e.g., PDA, phone, watch, tablet computers, netbook computers, . . . ), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

FIG. 10 illustrates a block diagram of a computing system 1000 operable to execute one or more parts of one or more of the disclosed example embodiments. Computer 1012, which can be, for example, part of the hardware of system 100, includes a processing unit 1014, a system memory 1016, and a system bus 1018. System bus 1018 couples system components including, but not limited to, system memory 1016 to processing unit 1014. Processing unit 1014 can be any of various available processors. Dual microprocessors and other multiprocessor architectures also can be employed as processing unit 1014.

System bus 1018 can be any of several types of bus structure(s) including a memory bus or a memory controller, a peripheral bus or an external bus, and/or a local bus using any variety of available bus architectures including, but not limited to, Industrial Standard Architecture (ISA), Micro-Channel Architecture (MSA), Extended ISA (EISA), Intelligent Drive Electronics, VESA Local Bus (VLB), Peripheral Component Interconnect, Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

System memory 1016 can include volatile memory 1020 and nonvolatile memory 1022. A basic input/output system (BIOS), containing routines to transfer information between elements within computer 1012, such as during start-up, can be stored in nonvolatile memory 1022. By way of illustration, and not limitation, nonvolatile memory 1022 can include ROM, PROM, EPROM, EEPROM, or flash memory. Volatile memory 1020 includes RAM, which acts as external cache memory. By way of illustration and not limitation, RAM is available in many forms such as SRAM, dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1012 can also include removable/non-removable, volatile/non-volatile computer storage media. FIG. 10 illustrates, for example, disk storage 1024. Disk storage 1024 includes, but is not limited to, devices like a magnetic disk drive, floppy disk drive, tape drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to system bus 1018, a removable or non-removable interface is typically used, such as interface 1026.

Computing devices typically include a variety of media, which can include computer-readable storage media or communications media, which two terms are used herein differently from one another as follows.

Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible media which can be used to store desired information. In this regard, the term “tangible” herein as may be applied to storage, memory or computer-readable media, is to be understood to exclude only propagating intangible signals per se as a modifier and does not relinquish coverage of all standard storage, memory or computer-readable media that are not only propagating intangible signals per se. In an aspect, tangible media can include non-transitory media wherein the term “non-transitory” herein as may be applied to storage, memory or computer-readable media, is to be understood to exclude only propagating transitory signals per se as a modifier and does not relinquish coverage of all standard storage, memory or computer-readable media that are not only propagating transitory signals per se. For the avoidance of doubt, the term “computer-readable storage device” is used and defined herein to exclude transitory media. Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

It can be noted that FIG. 10 describes software that acts as an intermediary between users and computer resources described in suitable operating environment 1000. Such software includes an operating system 1028. Operating system 1028, which can be stored on disk storage 1024, acts to control and allocate resources of computer system 1012. System applications 1030 take advantage of the management of resources by operating system 1028 through program modules 1032 and program data 1034 stored either in system memory 1016 or on disk storage 1024. It is to be noted that the disclosed subject matter can be implemented with various operating systems or combinations of operating systems.

A user can enter commands or information into computer 1012 through input device(s) 1036. As an example, mobile device and/or portable device can include a user interface embodied in a touch sensitive display panel allowing a user to interact with computer 1012. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, cell phone, smartphone, tablet computer, etc. These and other input devices connect to processing unit 1014 through system bus 1018 by way of interface port(s) 1038. Interface port(s) 1038 include, for example, a serial port, a parallel port, a game port, a universal serial bus (USB), an infrared port, a Bluetooth port, an IP port, or a logical port associated with a wireless service, etc. Output device(s) 1040 use some of the same type of ports as input device(s) 1036.

Thus, for example, a USB port can be used to provide input to computer 1012 and to output information from computer 1012 to an output device 1040. Output adapter 1042 is provided to illustrate that there are some output devices 1040 like monitors, speakers, and printers, among other output devices 1040, which use special adapters. Output adapters 1042 include, by way of illustration and not limitation, video and sound cards that provide means of connection between output device 1040 and system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. Remote computer(s) 1044 can be a personal computer, a server, a router, a network PC, cloud storage, cloud service, a workstation, a microprocessor based appliance, a peer device, or other common network node and the like, and typically includes many or all of the elements described relative to computer 1012.

For purposes of brevity, only a memory storage device 1046 is illustrated with remote computer(s) 1044. Remote computer(s) 1044 is logically connected to computer 1012 through a network interface 1048 and then physically connected by way of communication connection 1050. Network interface 1048 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit-switching networks like Integrated Services Digital Networks (ISDN) and variations thereon, packet switching networks, and Digital Subscriber Lines (DSL). As noted below, wireless technologies may be used in addition to or in place of the foregoing.

Communication connection(s) 1050 refer(s) to hardware/software employed to connect network interface 1048 to bus 1018. While communication connection 1050 is shown for illustrative clarity inside computer 1012, it can also be external to computer 1012. The hardware/software for connection to network interface 1048 can include, for example, internal and external technologies such as modems, including regular telephone grade modems, cable modems and DSL modems, ISDN adapters, and Ethernet cards.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory.

As used in this application, the terms “component,” “system,” “platform,” “layer,” “selector,” “interface,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media, device readable storage devices, or machine readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

Moreover, terms like “user equipment (UE),” “mobile station,” “mobile,” subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “access point (AP),” “base station,” “NodeB,” “evolved Node B (eNodeB),” “home Node B (HNB),” “home access point (HAP),” “cell device,” “sector,” “cell,” and the like, are utilized interchangeably in the subject application, and refer to a wireless network component or appliance that serves and receives data, control, voice, video, sound, gaming, or substantially any data-stream or signaling-stream to and from a set of subscriber stations or provider enabled devices. Data and signaling streams can include packetized or frame-based flows.

Additionally, the terms “core-network”, “core”, “core carrier network”, “carrier-side”, or similar terms can refer to components of a telecommunications network that typically provides some or all of aggregation, authentication, call control and switching, charging, service invocation, or gateways. Aggregation can refer to the highest level of aggregation in a service provider network wherein the next level in the hierarchy under the core nodes is the distribution networks and then the edge networks. UEs do not normally connect directly to the core networks of a large service provider but can be routed to the core by way of a switch or radio area network. Authentication can refer to determinations regarding whether the user requesting a service from the telecom network is authorized to do so within this network or not. Call control and switching can refer determinations related to the future course of a call stream across carrier equipment based on the call signal processing. Charging can be related to the collation and processing of charging data generated by various network nodes. Two common types of charging mechanisms found in present day networks can be prepaid charging and postpaid charging. Service invocation can occur based on some explicit action (e.g. call transfer) or implicitly (e.g., call waiting). It is to be noted that service “execution” may or may not be a core network functionality as third party network/nodes may take part in actual service execution. A gateway can be present in the core network to access other networks. Gateway functionality can be dependent on the type of the interface with another network.

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks include Geocast technology; broadcast technologies (e.g., sub-Hz, ELF, VLF, LF, MF, HF, VHF, UHF, SHF, THz broadcasts, etc.); Ethernet; X.25; powerline-type networking (e.g., PowerLine AV Ethernet, etc.); femto-cell technology; Wi-Fi; Worldwide Interoperability for Microwave Access (WiMAX); Enhanced General Packet Radio Service (Enhanced GPRS); Third Generation Partnership Project (3GPP or 3G) LTE; 3GPP Universal Mobile Telecommunications System (UMTS) or 3GPP UMTS; Third Generation Partnership Project 2 (3GPP2) Ultra Mobile Broadband (UMB); High Speed Packet Access (HSPA); High Speed Downlink Packet Access (HSDPA); High Speed Uplink Packet Access (HSUPA); GSM Enhanced Data Rates for GSM Evolution (EDGE) Radio Access Network (RAN) or GERAN; UMTS Terrestrial Radio Access Network (UTRAN); or LTE Advanced.

What has been described above includes examples of embodiments illustrative of the disclosed subject matter. It is, of course, not possible to describe every combination of components or methods herein. One of ordinary skill in the art may recognize that many further combinations and permutations of the disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A system comprising:
a processor; and
a memory that stores instructions that, when executed by the processor, facilitates performance of operations, comprising:
receiving social media data associated with a user identity from social media operator entity equipment associated with a social media operator entity;
creating, based on the social media data and a learning model representative of a collection of rules, an attributable identity token representing experience data representative of experiences associated with the user identity and location data representative of locations associated with the experiences; and
distributing the attributable identity token to social media accounts associated with a group of user identities comprising the user identity, wherein the group of user identities is associated with the social media operator entity.

2. The system of claim 1, wherein the operations further comprise identifying, based on the social media data, a location of the location data and a time corresponding to the location, and determining, based on the location and the time, that a user associated with the user identity attended an event that took place at the location and the time.

3. The system of claim 2, wherein the location of the location data comprises a coordinate representing a geographic longitude and a geographic latitude associated with the event.

4. The system of claim 3, wherein the location data represents geo-fencing data indicative of boundaries associated with the user identity, and wherein the location of the location data comprises a geo-fence of the geo-fencing data indicative of a boundary associated with the event.

5. The system of claim 1, wherein the attributable identity token is a tuple of a collection of tuples.

6. The system of claim 1, wherein the operations further comprise clustering the attributable token in a cluster of attributable identity tokens based on a time stamp value included in the social media data.

7. The system of claim 1, wherein the operations further comprise generating an experience token based on the experience data, and wherein the experience data comprises content input via social media accounts associated with the user identity.

8. The system of claim 7, wherein the operations further comprise distributing the experience token to the social media accounts associated with the group of user identities.

9. The system of claim 8, wherein the user identity is a first user identity, and wherein the operations further comprise based on the distributing of the experience token, determining that user input, associated with a second user identity that is a member of the group of user identities, has resulted in the experience token being updated.

10. The system of claim 9, wherein the user input associated with the second user identity that has resulted in the experience token being updated comprises a comment input with respect to the experience token associated with the second user identity that results in the comment being associated with the experience token.

11. The system of claim 9, wherein the user input associated with the second user identity that has resulted in the experience token being updated comprises an emoticon input with respect to the experience token associated with the second user identity that results in the emoticon being associated with the experience token.

12. A method, comprising:
receiving, by a device comprising a processor, social media data associated with a user associated with a user identity;
generating, by the device, an attributable identity token based on the social media data and a learning model, wherein the attributable identity token is associated with the user identity and is representative of location data representative of locations associated with the user identity and experience data representative of experiences associated with the user identity, and wherein the learning model applies a collection of rules; and
disseminating, by the device, the attributable identity token to a group of user identities associated with a social media operator entity.

13. The method of claim 12, wherein the attributable identity token is an element of a linked list of attributable identity tokens, and wherein at least the location data is at a head end of the element of the linked list of the attributable identity tokens, and the experience data is linked to the head end.

14. The method of claim 12, further comprising, based on geographic coordinate data associated with the location data, classifying, by the device, the attributable identity token and associating the attributable identity token with a collection of attributable identity tokens associated with the geographic coordinate data.

15. The method of claim 12, further comprising, based on the attributable identity token, generating, by the device, an experience token representing content input via a social media account associated with the user identity describing an experience that occurred at an attraction associated with the location data.

16. The method of claim 15, wherein the user identity is a first user identity, and further comprising distributing, by the device, the experience token to social media accounts respectively associated with user identities comprising at least the first user identity and a second user identity.

17. The method of claim 16, further comprising determining, by the device, that the emoticon data, representing a graphic exhibiting a positive reaction to the experience that occurred at the attraction, has been input via a social media account associated with the second user identity.

18. The method of claim 17, further comprising adapting, by the device, a learning rule of the collection of rules applied by the learning model based on the emoticon data.

19. A non-transitory machine-readable medium, comprising executable instructions that, when executed by a processor, facilitate performance of operations, comprising:
receiving, from a server of a social media operator entity, social media data representative of social media interactions associated with a user associated with a user identity;
registering, based on the social media data and a learning model representative of a collection of rules, an attributable identity token representing experience data representative of an experience associated with the user identity and location data representative of locations associated with the user identity; and
distributing the attributable identity token to respective social media accounts of a group of user identities associated with the social media operator entity.

20. The non-transitory machine-readable medium of claim 19, wherein the operations further comprise, based on received geographic coordinate data associated with the location data and received timing data associated with the geographic coordinate data, classifying the attributable identity token and including the attributable identity token in a collection of attributable identity tokens associated with the geographic coordinate data.
